(19) United States
(12) Patent Application Publication
(10) Pub. No.: US 2021/0404539 A1
(43) Pub. Date: Dec. 30, 2021

(54) BELT DRIVE AUTOMATIC ADJUSTMENT SYSTEM AND METHOD

(71) Applicant: E&C FinFan, Inc., Bali Ground, GA (US)

(72) Inventors: Jeffrey Scoville, Broken Arrow, OK (US); Michael Lanphier, Owasso, OK (US); Michael Lee, Catoosa, OK (US); David Snell, Glenpool, OK (US)

(21) Appl. No.: 17/349,319

(22) Filed: Jun. 16, 2021

Related U.S. Application Data
(60) Provisional application No. 63/045,534, filed on Jun. 29, 2020.

(51) Int. Cl. F16H 7/14; F04D 25/08

(52) U.S. Cl. CPC F16H 7/14; F16H 2007/0876; F04D 25/08

(57) ABSTRACT

A belt drive system includes a drive sheave and a driven sheave. A drive motor turns the drive sheave when the drive motor is activated. A drive belt is connected to the drive sheave and the driven sheave so that the driven sheave is turned when the drive motor is activated. The drive motor is mounted upon a shuttle and the shuttle is slidingly mounted on a base. A drive system moves the shuttle when the adjustment motor is activated so that a position of the drive sheave relative to the driven sheave may be adjusted so as to increase a tension in the drive belt. A controller activates the adjustment motor when slippage of the drive belt on either the drive sheave or the driven sheave is detected.

### CLAIM OF PRIORITY

This application claims the benefit of U.S. Provisional Application No. 63/045,534, filed Jun. 29, 2020, the contents of which are hereby incorporated by reference.

### FIELD OF THE DISCLOSURE

The present disclosure relates generally to systems for detecting and eliminating belt slippage on drive systems, more particularly, to a belt drive automatic adjustment system and method.

### BACKGROUND

Belt driven fan systems are applicable in a variety of industrial settings. They can be utilized in heating and cooling applications. Particularly, belt driven fan systems are utilized in air-cooled heat exchangers. Belt driven fan systems utilize an independent motor that is connected to the fan through a series of sheaves and at least one belt. The inner side of the belt is wrapped around the sheaves.

Tension in the belt of the belt driven fan system should remain relatively constant. When tension decreases, a belt will start slipping. Damage may occur to the fan shaft and fan blades of the belt driven fan system when a belt is slipping. The belt will typically “stick-slip” which means that the fan shaft and fan blades are exposed to large variations in angular speed as the belt disengages and reengages the sheave, sometimes several times a revolution.

Current belt driven fan systems may utilize an auto tensioner, which consists of a spring or elastomer loaded arm that keeps tension in the drive system constant (until the limits of the spring/elastomer are reached). The belt tension is checked when the system is offline.

The above-described system does not provide a method for detecting and eliminating belt slippage “online” with the sheaves and belt operating.

It is desirable to provide a system and method for determining that a belt is slipping and eliminating the belt slippage, while the drive system is in operation, to provide re-tensioning before significant damage occurs.

### SUMMARY OF THE DISCLOSURE

There are several aspects of the present subject matter which may be embodied separately or together in the methods, devices and systems described and claimed below. These aspects may be employed alone or in combination with other aspects of the subject matter described herein, and the description of these aspects together is not intended to preclude the use of these aspects separately or the claiming of such aspects separately or in different combinations as set forth in the claims appended hereto.

In one aspect, a belt drive system includes a drive sheave and a driven sheave. A drive motor is configured to turn the drive sheave when the drive motor is activated. A drive belt is operatively connected to the drive sheave and the driven sheave so that the driven sheave is turned with the drive motor is activated. The drive motor is mounted on a shuttle. The shuttle is slidingly mounted on a base. A drive system is configured to move the shuttle when an adjustment motor is activated so that a position of the drive sheave relative to the driven sheave may be adjusted so as to increase a tension in the drive belt. A controller is configured to activate the adjustment motor when slippage of the drive belt on either the drive sheave or the driven sheave is detected.

In another aspect, a method for automatically adjusting a belt drive system having a drive sheave powered by a drive motor and a driven sheave powered by the drive sheave via a drive belt includes the steps of detecting slippage of the drive belt on the drive sheave or the driven sheave using a controller, activating an adjustment motor via the controller to increase the tension in the drive belt when the drive belt slippage is detected and deactivating the adjustment motor via the controller when the drive belt slippage is no longer detected.

### BRIEF DESCRIPTION OF THE DRAWINGS

FIG. 1 is a schematic illustration of a first embodiment of the system of the disclosure.

FIG. 2 is a sectional view of the motor sheave portion of the system of FIG. 1.

FIG. 3 is a sectional view of the fan sheave portion of the system of FIG. 1

FIG. 4 is a sectional view of the controller box portion of the system of FIG. 1.

FIG. 5A is a schematic illustration of a second embodiment of the system of the disclosure.

FIG. 5B is an enlarged view of the adjustment motor shaft and the adjustment motor shaft coupler of FIG. 5A.

FIG. 6 is an enlarged partial front perspective view of the system of FIG. 5A.

FIG. 7 is an enlarged partial rear perspective view of the system of FIG. 5A.

### DETAILED DESCRIPTION OF EMBODIMENTS

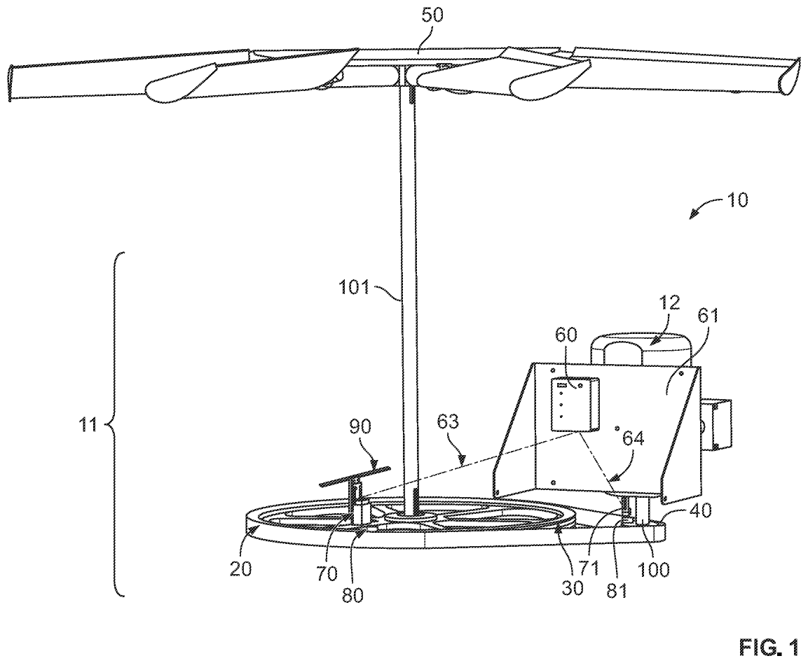

An embodiment of the disclosure illustrated in FIGS. 1-4 provides a belt driven fan system for indicating belt slippage while in use and/or online.

While embodiments of the disclosure are described with reference to a belt drive system for a fan, the technology of the disclosure may be applied to any belt driven device or system.

FIG. 1 indicates in general a first embodiment of the belt driven fan system 10 of the current disclosure. In the illustrated embodiment, belt driven fan system 10 has a fan 50 powered via a drive system 11 and a motor 12.

The drive system 11 is comprised of a number of parts. Drive system 11 includes a fan sheave 30 and a motor sheave 40 and associated shafts. Fan shaft 101 is connected on one end to fan 50 and on the other end to fan sheave 30. Motor shaft 100 is connected to motor 12 and motor sheave 40. Both sheaves may be grooved wheels for holding a belt or rope. Both sheaves can be made of various metals, for example, iron, steel, and aluminum. The sheaves can also be made of lighter materials, such as plastics. Both fan sheave 30 and motor sheave 40 can be circular in shape. They can be comprised of an inner portion, attached to a shaft, and an outer portion, or rim. As shown in FIG. 1, the fan sheave is larger in diameter than the motor sheave. In alternate systems, the sheaves may be arranged and sized differently. Although FIG. 1 shows two sheaves, the system may include additional functioning sheaves.

Fan sheave and motor sheave are connected by drive belt 20 and are on the inner side of belt 20. The belt 20, extends around the diameters of the fan sheave 30 and motor sheave 40. The belt size is normally adjusted to fit the width of the largest sheave. The belt size is also adjustable to the size and number of sheaves present. The drive belt 20 is comprised of a flexible material and can be made of rubber or other polymers.

Each sheave has an associated marker securely placed on a portion of the surface that is read by an associated sensor, preferably the sheave top or bottom surface. Fan sheave 30 has a fan sheave marker 80. Motor sheave 40 has marker 81 on its surface. As will be discussed further below, the marker composition is based in part on the associated sensor type. The marker may be attached to each sheave by any known conventional means and is also partly based on marker type. For example, the marker or markers may be placed on either sheave by chemical, mechanical or magnetic means. The marker position is such that it is read by the sensor once per revolution of the respective sheave. In one embodiment, the markers are placed on the rims of the sheaves.

Each sheave has an associated sensor. Each sensor is positioned on a device or housing to easily read the associated sheave marker. Fan sheave has sensor 70 which is suspended from an arm or other structure, 90, shown in phantom, that holds the sensor in place. Motor sheave 40 has sensor 71, which is attached to motor 12. The sensor can be any device that can read a marker as it passes and relay the information to a data collecting member. The sensors and markers are configured so that each sensor can read or detect the associated marker when the sheave completes each revolution. Sensors can utilize a wired or wireless source of power, connected to the respective sensor.

The sensors can be any one of a number of proximity sensors. Examples of proximity sensors include ultrasonic sensors, capacitive, photoelectric, inductive, or magnetic sensors. In one embodiment, the sensor can be a magnetic sensor. In a further embodiment the sensor is a Hall-effect sensor or reed sensor. Hall-effect sensors, when utilized, can be comprised of conductive material such as silicon or other semi-conductors. A particular embodiment utilizes indium antimonide. When a magnetic sensor, such as the Hall-effect or reed sensor, is used, the associated marker can be a magnet. In a particular embodiment, the magnet is a rare earth magnet. Rare earth magnets can be comprised of different alloys of rare earth elements, such as Neodymium and Samarium Cobalt. When other sensors are utilized, an appropriate marker can be selected. Marker/sensor systems can be magnetic, infrared, or light based or any other technology that allows the microcontroller to determine the time of rotation of the sheave.

Belt driven fan system 10 also includes a housing 61 and controller box 60 containing a controller. The controller can be a microcontroller or any other computer device. Housing 61 may contain various fixtures or elements, including a mounting bracket for the motor associated with motor sheave 40. The controller is in communication, as shown by dotted lines 63 and 64, with fan sheave sensor 70 and motor sheave sensor 71. Controller can be wired or wirelessly connected to each sensor.

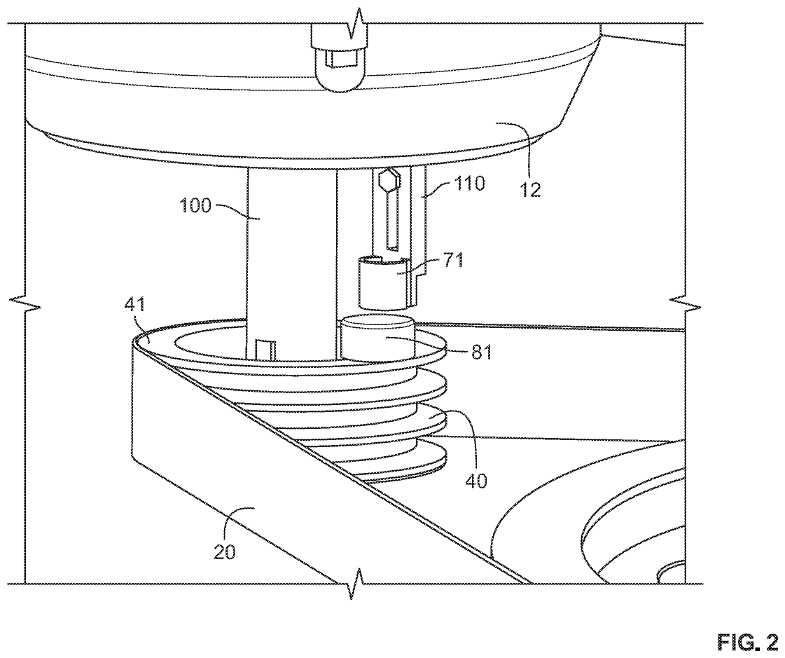

FIG. 2 shows an enlarged view of the motor sheave 40 of the belt driven fan system 10. Motor sheave 30 is attached to motor sheave shaft 100. Motor sheave 40 has motor sheave marker 81 attached to a top surface of the sheave, preferably on rim 41. Motor sensor attachment 110 connects the motor sheave sensor 71 to motor 12. Alternatively, motor sensor attachment 110 can be connected to housing 61 or an arm or other fixture. Motor sensor attachment 110 can be any suitable connector type. As sheave 40 rotates, sensor 71 registers each pass of marker 81 as a revolution.

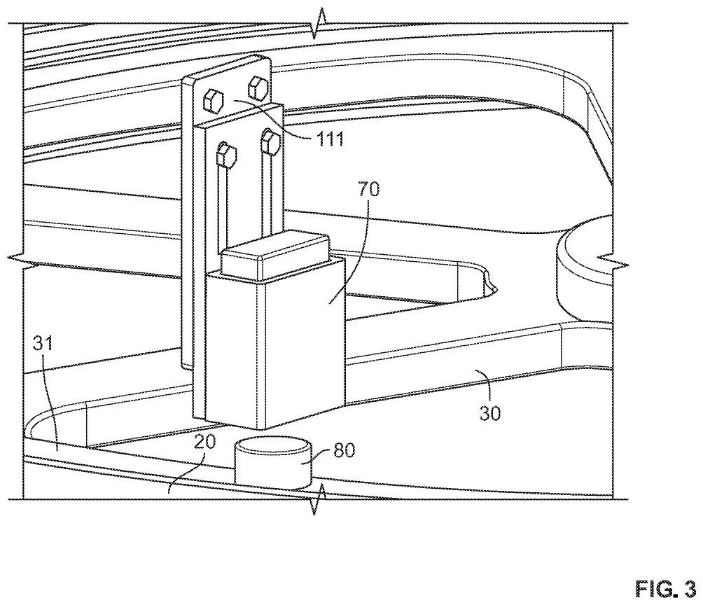

FIG. 3 shows an enlarged view of the fan sheave section of the belt drive fan system 10. As seen more clearly in FIG. 3, fan sheave marker 80 is attached to the rim 31 of the fan sheave 30 on a top surface. Fan sheave sensor 70 is held in place by fan sensor attachment 111. Fan sensor attachment 111 is connected to an arm or other fixture, not shown in FIG. 3 (shown in phantom at 90 in FIG. 1), that holds the attachment and connected sensor in place.

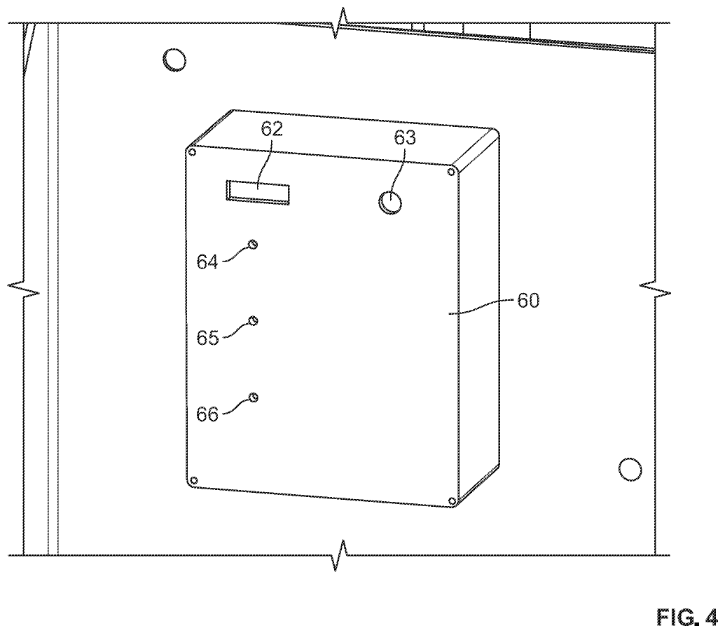

FIG. 4 shows an enlarged view of the controller box 60 which houses a controller. The controller box 60 can be used to relay a variety of information to a user so that they are aware of the current status of the belt driven fan system 10. The controller box 60 can include a memory slot 62 for placing a device used to record information, such as an SD card, USB or thumb drive, or a connector to another computing device. The slot 62 can be used to can store information over time to provide useful data in the event of an issue or as part of a normal maintenance check. Controller box 60 can also include several indicator lights. As shown in FIG. 4, it can include three different indicators, belt slip indicator 64, error indicator 65 and ready indicator 66. Controller 60 can also include a reset button or switch 63.

In order to calculate belt slippage in the belt driven fan system 10 of the current disclosure, both fan sheave sensor 70 and motor sheave sensor 71 detect each passing revolution of their associated marker. Each sensor relays this information to the controller for calculating the number of revolutions per minute for each of the motor sheave and fan sheave. A ratio between the motor sheave and the fan sheave can be calculated. If the belt tension is constant and the belt is not slipping, the ratio between the two sheaves, as calculated, should remain consistent. If and when the belt starts slipping, the ratio of the motor sheave RPM to the fan sheave RPM will increase over time. The controller can be programmed to trigger a visual indication on the controller box when the RPM ratio increases above a certain percentage. For example, a 2-3% increase can be selected to trigger a warning and visual indication. This approach is conservative and will catch a slipping belt much quicker than an audible indication of slipping, which typically occurs around a 30% increase in this ratio. If belt slippage is present, it can quickly be acted on before any significant damage is done.

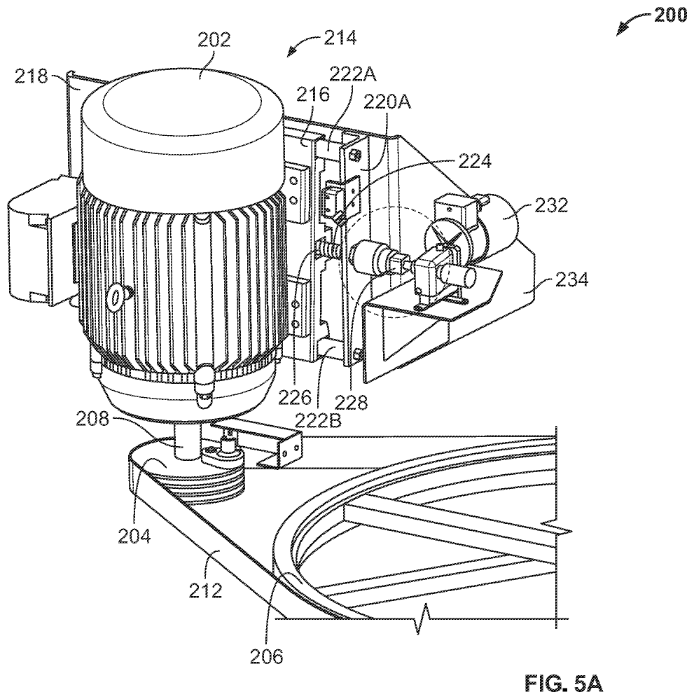

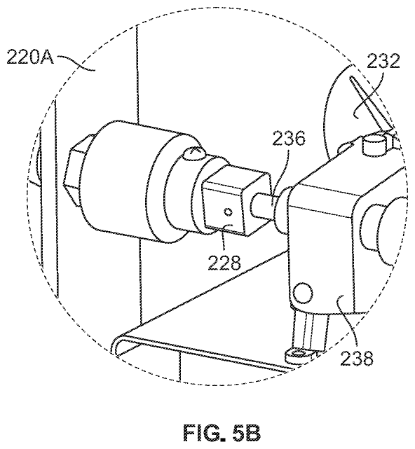

A second embodiment of the disclosure illustrated in FIGS. 5A-7 provides a system for detecting and eliminating belt slippage while a belt driven fan system is in use and/or online.

A system for driving a fan is indicated in general at 200 in FIGS. 5A, 6 and 7 includes a drive or fan motor 202, a drive or motor sheave 204 and a driven or fan sheave 206. The motor sheave 204 is turned by the fan motor 202 via fan motor shaft 208. The fan sheave 206 has a centrally extending fan shaft (not shown) upon which is mounted a fan (as shown in FIG. 1). Both sheaves may be grooved wheels for holding a belt or rope. Both sheaves can be made of various metals, for example, iron, steel, and aluminum. The sheaves can also be made of lighter materials, such as plastics. As shown in FIGS. 5A, 6 and 7, the fan sheave is larger in diameter than the motor sheave. In alternate systems, the sheaves may be arranged and sized differently. Although FIGS. 5A, 6 and 7 show two sheaves, the system may include additional functioning sheaves.

Fan sheave 206 and motor sheave 204 are connected by drive belt 212 with the drive belt being slightly tensioned as it extends around the sheaves. The drive belt 212 is comprised of a flexible material, examples including, but not limited to, rubber or polymers.

As in the previous embodiment, when the fan motor 202 is activated, shaft 208 turns with the motor sheave 204 turning as a result. This causes the fan sheave 206 to turn via belt 212. The fan motor 202 is preferably an electric motor.

As illustrated in FIGS. 5A, 6 and 7, the fan motor 202 is mounted upon an automatic slide base, indicated in general at 214. More specifically, the automatic slide base includes a carriage or shuttle 216 to which the fan motor 202 is mounted. The automatic slide base also includes a base, taking the form of a base plate 218, upon which is mounted flanges 220a and 220b between which extend slide rails 222a and 222b. The base may take a form other than a base plate. Shuttle 216 is mounted to the slide rails 222a and 222b so that the shuttle, and thus fan motor 202, may move in a direction parallel to the surface of the base plate 218. The base plate 218 is mounted to a wall, floor or other surface that is stationary relative to the shuttle 216 and fan motor 202. As an example only, the automatic slide base may be a 600 Series Automatic Motor Base available from the Overly Hautz Motor Base Company of Lebanon, Ohio.

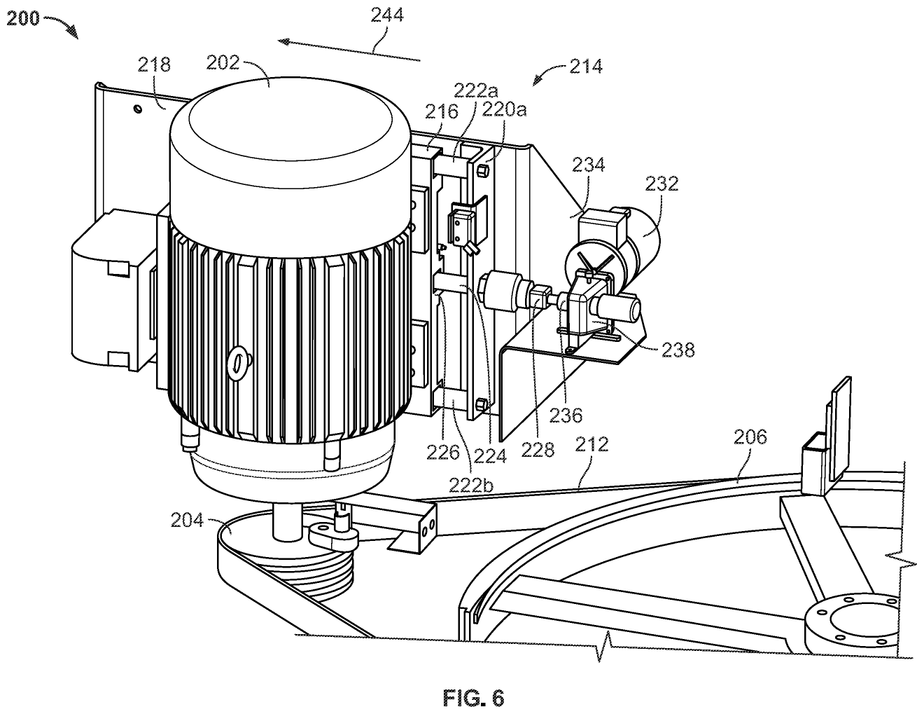

A threaded drive rod 224 extends though flange 220a and has a distal end that is received by a threaded socket 226 (FIGS. 5A and 6) provided in shuttle 216. As a result, the shuttle 216, and thus fan motor 202, moves along slide rails 222a and 222b with respect to base plate 218 as the drive rod 224 is rotated. The proximal end of the drive rod 224 is provided with an adjustment motor shaft coupler 228 (best shown in FIG. 5B).

An adjustment motor 232 is mounted to the base plate 218 via side panel 234 (so that the base plate 218, side panel 234 and an opposing side panel may form a housing). The adjustment motor is preferably an electric motor and turns an adjustment motor shaft 236 (FIG. 5B) via gearbox 238, which includes a gear-reducer/right angle drive, when activated. As best shown in FIG. 5B, the adjustment motor shaft 236 is connected to drive rod 224 via adjustment motor shaft coupler 228 so that the drive rod 224 is rotated when the adjustment motor 232 is activated.

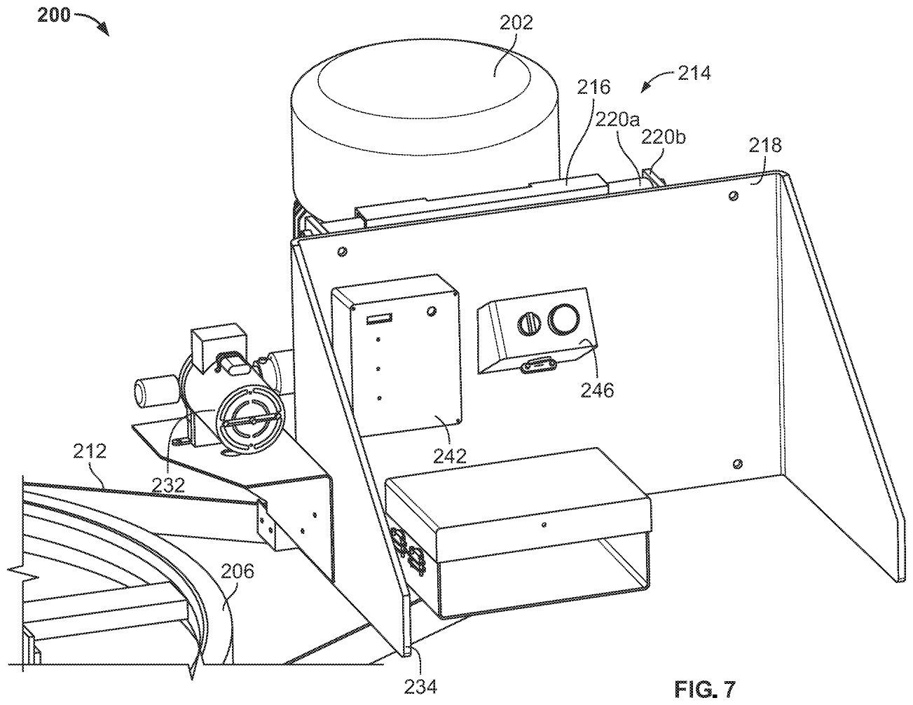

As illustrated in FIG. 7, a controller 242 is mounted to base plate 218. The controller can be a microcontroller or any other computer device. As in the previous embodiment, the controller is in communication with a fan sheave sensor and a motor sheave sensor (via either a wired connection of wirelessly) so that belt slippage may be detected. The controller 242 is also connected to the adjustment motor 232 and a power source for the motor.

In operation, if the controller 242 detects belt slippage in the manner described for the previous embodiment above, the controller turns on the adjustment motor 232. As a result, adjustment motor shaft 236, adjustment motor shaft coupler 228 and the drive rod 224 are rotated and the shuttle 216 and fan motor 202 move in the direction of arrow 244 in FIG. 6. This causes the motor sheave 204 to move away from the fan sheave 206 so as to increase the tension in the belt 212 to the extent necessary to eliminate the belt slippage. In one embodiment, the controller 242 may be configured so that when belt slippage is detected, the adjustment motor 232 is activated to move the motor sheave 204. This movement continues until the controller 242 senses that the belt slippage has stopped. The adjustment motor 232 is then deactivated.

With reference to FIG. 7, the rate of movement of the shuttle 216 and fan motor 202 by the controller may be adjusted and calibrated using controls 246 mounted adjacent to the controller 242.

Other drive systems known in the art may be used in place of threaded drive rod 224 to move the shuttle 216 when the adjustment motor 232 is activated. Such arrangements include, but are not limited to, linkages, rack and gear drives, chain drives and/or belt drives.

In alternative embodiments, the tension in the drive belt may be increased, when belt slippage is detected, by moving a third sheave against either the inner surface or outer surface of the drive belt using the adjustment motor. Alternatively, the driven sheave may be moved away from the drive or motor sheave. Furthermore, the adjustment motor may be used to otherwise increase the distance between the drive and driven sheaves.

While the preferred embodiments of the disclosure have been shown and described, it will be apparent to those skilled in the art that changes and modifications may be made therein without departing from the spirit of the disclosure, the scope of which is defined by the following claims.

What is claimed is:

1. A belt drive system comprising:
a drive sheave;
a driven sheave;
a drive motor configured to turn the drive sheave when the drive motor is activated;
a drive belt operatively connected to the drive sheave and the driven sheave so that the driven sheave is turned when the drive motor is activated;
a shuttle upon which the drive motor is mounted;
a base upon which the shuttle is slidingly mounted;
an adjustment motor;
a drive system configured to move the shuttle when the adjustment motor is activated so that a position of the drive sheave relative to the driven sheave may be adjusted so as to increase a tension in the drive belt;
a controller configured to activate the adjustment motor when slippage of the drive belt on either the drive sheave or the driven sheave is detected.

2. The belt drive system of claim 1 further comprising:
a driven sheave marker positioned on a surface of the driven sheave;
a drive sheave marker positioned on a surface of the drive sheave;
a driven sheave sensor;
a drive sheave sensor;
wherein the controller in communication with the fan sheave sensor and the motor sheave sensor so that slippage of the drive belt on either the drive sheave or the driven sheave may be detected.

3. The drive belt system of claim 2 wherein the driven and drive sheave markers are magnets.

4. The belt drive system of claim 1 wherein the shuttle includes a threaded bore and the drive system includes a threaded rod that engages the threaded bore on the shuttle, where the threaded rod is operatively connected to the adjustment motor so that the threaded rod turns when the adjustment motor is activated.

5. The belt drive system of claim 4 wherein the base includes a base plate have a pair of slide rails mounted thereon wherein said shuttle is configured to slide on the slide rails when the adjustment motor is activated.

6. The belt drive system of either one of claims 4 wherein the adjustment motor includes an adjustment motor shaft and further comprising an adjustment motor shaft coupler connecting the threaded rod to the adjustment motor shaft.

7. The belt drive system of claim 1 wherein the controller is configured to deactivate the adjustment motor when slippage of the drive belt is no longer detected.

8. The belt drive system of claim 1, further comprising a fan shaft having a fan connected to the driven sheave.

9. The belt drive system of claim 8, wherein the system is a component of an air-cooled heat exchanger.

10. A method for automatically adjusting a belt drive system having a drive sheave powered by a drive motor and a driven sheave powered by the drive sheave via a drive belt, the method comprising the steps of:
detecting slippage of the drive belt on the drive sheave or the driven sheave using a controller;
activating an adjustment motor via the controller to increase the tension in the drive belt when the drive belt slippage is detected; and
deactivating the adjustment motor via the controller when the drive belt slippage is no longer detected.

11. The method of claim 10 wherein the tension in the drive belt is increased by increasing the distance between the drive sheave and the driven sheave.

12. The method of claim 11 wherein the distance between the drive sheave and the driven sheave is increased by moving the drive sheave away from the driven sheave.

13. The method of claim 12 wherein the drive sheave is moved away from the driven sheave by moving the drive motor.

14. The method of claim 10 wherein the step of detecting slippage of the drive belt includes the steps of:
calculating a first RPM ratio of the motor sheave to the fan sheave using sheave markers at a first time;
calculating a second RPM ratio of motor sheave to the fan sheave using the sheave markers a second time;
comparing the first RPM ratio to the second RPM ratio to determine whether the belt is slipping.
